(19) United States
(12) Patent Application Publication
(10) Pub. No.: US 2019/0022566 A1
(43) Pub. Date: Jan. 24, 2019

(54) AIR FILTRATION MEDIA AND METHOD OF PROCESSING THE SAME

(71) Applicants: Chaojun LIU, Morris Plains, NJ (US); Li WANG, Morris Plains, NJ (US); Honeywell International Inc., Morris Plains, NJ (US)

(72) Inventors: Chaojun Liu, Shanghai (CN); Li Wang, Shanghai (CN)

(21) Appl. No.: 16/080,918

(22) PCT Filed: Feb. 29, 2016
(86) PCT No.: PCT/CN2016/074794

§ 371 Date: Aug. 29, 2018

(30) Foreign Application Priority Data
Feb. 29, 2016 (CN) PCT/CN2016/074794

(51) Int. Cl. B01D 39/20; B01D 39/16; B01J 35/04

(52) U.S. Cl. CPC B01D 39/201; B01D 39/1623; B01D 2239/10; B01D 2239/0407; B01J 35/04

(57) ABSTRACT

Air filtration media and methods of processing the same are described herein. One method of processing an air filtration medium includes mixing an adsorption material, a polymer material, and a reinforcement material, compressing the mixture, and heating the mixture.

### TECHNICAL FIELD

The present disclosure relates to air filtration media and methods of processing the same.

### BACKGROUND

Air filters are used in air purifiers, heating, ventilation, and air conditioning (HVAC) systems, kitchen ventilators, vacuum cleaners, and in other applications. Filters can remove gas pollutants from air. These pollutants can include, for example, volatile organic compounds (VOCs), formaldehyde, sulfur dioxide, and others.

Some previous approaches to air filtration use a filter with a honeycomb plastic structure that houses an adsorption material. Due to the size and shape limitations presented by these honeycomb structures, however, the amount of adsorption material that can be incorporated in to the filter may be limited. Thicknesses of plastic honeycomb walls may range from 2-5 millimeters, in some instances.

Portions of an air filter that are occupied by thick plastic structural elements are portions that may not adsorb pollutants. As a result, these approaches may not permit gas pollutants to encounter enough adsorption material on their way through the filter such that they are sufficiently removed from the air.

### BRIEF DESCRIPTION OF THE DRAWINGS

FIG. 1 illustrates a method of processing an air filtration medium in accordance with one or more embodiments of the present disclosure.

FIG. 2 illustrates a cross-sectional view of an example air filtration medium in accordance with one or more embodiments of the present disclosure.

FIG. 3 illustrates a cross-sectional view of another example air filtration medium in accordance with one or more embodiments of the present disclosure.

### DETAILED DESCRIPTION

Air filtration media and methods of processing air filtration media are described herein. For example, one or more embodiments include mixing an adsorption material, a polymer material, and a reinforcement material, compressing the mixture, and heating the mixture.

Embodiments of the present disclosure can increase the efficiency of air filtration over previous approaches by increasing a ratio of adsorption material to structural elements contained in a filter. Embodiments herein can allow gas pollutants to encounter more adsorption material as they pass through a filter, thus increasing the ability of the filter to adsorb these pollutants and remove them from air.

In some embodiments, an adsorption material can be mixed with a polymer material (sometimes referred to herein as simply “polymer”) and a reinforcement material. It is noted that more than one adsorption material, polymer, and reinforcement material can be used. The mixture can be compressed and heated, during which the polymer can melt. Once cooled, the hardened polymer adhesively bonds to the adsorption material and the reinforcement material in a rigid (or semi-rigid) filter medium. The medium can be trimmed to a desired size and/or shape, for instance, and can be used to filter gas pollutants out of air.

Embodiments of the present disclosure can be tailored to particular filtering needs and/or applications. For instance, in some areas, antibacterial properties of an air filter may be desired. A filter medium in accordance with one or more embodiments of the present disclosure can include Nano Silver particles to strengthen an antibacterial performance of the filter. Additionally, and as discussed further below, the particular types of adsorption material(s), polymer(s), and/or reinforcement material(s) used in a filter medium can be selected based on desired performance characteristics and/or structure, for instance.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

The figures herein follow a numbering convention in which the first digit or digits correspond to the drawing figure number and the remaining digits identify an element or component in the drawing.

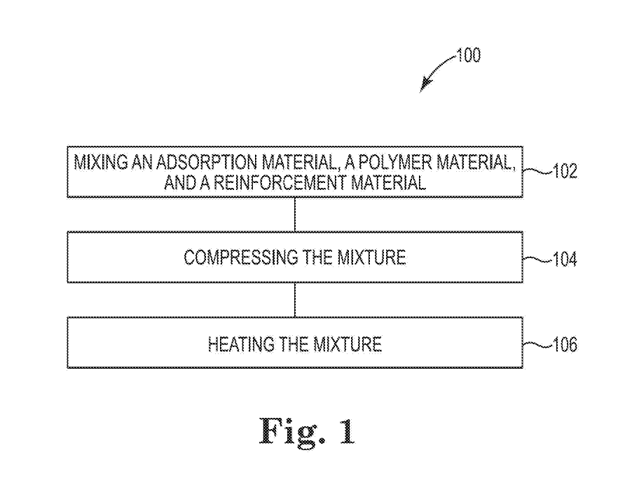

FIG. 1 illustrates a method 100 of processing an air filtration medium in accordance with one or more embodiments of the present disclosure.

At block 102, method 100 includes mixing an adsorption material, a polymer, and a reinforcement material. For example, each of the materials can be in a solid state. In some embodiments, one or more of the materials can contain particles and/or granules. In some embodiments, for example, the adsorption material can include cylindrical particles and/or spherical particles. In some embodiments, one or more of the materials can be powders.

Mixing the materials can include adding particular amounts of the materials. For example, in some embodiments, the adsorption material can be added such that, by weight, it comprises between 50 and 90 percent of the mixture; the reinforcement material and the polymer can be added such that, by weight, their combination comprises between 5 and 50 percent of the mixture.

In some embodiments, the reinforcement material and the polymer can be equal portions of the mixture by weight. In some embodiments, the reinforcement material and the polymer can be differing portions of the mixture by weight. It is to be understood that the amount(s) of the components comprising the mixture can be selected based on desired performance characteristics and/or structure of the filter media. For instance, a desired rigidity of the filter media may be controlled by the amount and/or type of reinforcement material used in the mixture.

The adsorption material is one or more materials that can adsorb gaseous pollutants. Gaseous pollutants, as referred to herein, include oil vapors, odors, radioactive gases, hydrocarbons, etc. In some embodiments, the adsorption material can be and/or include activated carbon, a molecular sieve material, and diatomite. For example, the adsorption material can include activated (e.g., carbonized) charcoal, pitch, and/or cellulose fibers, among others.

In some embodiments, the adsorption material can include powdered activated carbon (e.g., granules of less than 1 millimeter in diameter), granular activated carbon (e.g., designated by sizes such as 4×6, 4×8, and/or 4×10), extruded activated carbon (e.g., cylindrically-shaped particles with diameters of approximately 0.8 millimeters to 130 millimeters), bead activated carbon (e.g., spherically-shaped particles with diameters from approximately 0.35 millimeters to 3 millimeters), and/or impregnated carbon (e.g., carbons containing one or more inorganic impregnates).

The size, shape, and/or type of adsorption material particles can be selected based on various factors. For example, the size, shape, and/or type of adsorption material can be selected based on the particular application (e.g., type of filter), the desired flow rate of air through the filter media, and/or the type(s) of pollutants to be adsorbed.

The polymer can be a synthetic plastic, for instance. In some embodiments, the polymer can be and/or include polypropylene, low-density polyethylene, and/or high-density polyethylene. The polymer can be a powder and/or a fiber, for instance. The polymer can be comprised of particles having a particular size range. The type of polymer can be selected based on its melting point, in some embodiments. The type of polymer can be selected based on its chemical and physical interactions (when melted) with the adsorption material and/or reinforcement material in the mixture.

The reinforcement material can be a fiber, for instance, and can provide rigidity and/or structure to filter media described herein. In some embodiments, the reinforcement material may provide adsorption in addition to that provided by the adsorption material. The reinforcement material can be and/or include, for example, activated carbon fiber, glass fiber, basalt fiber, polyethylene terephthalate fiber, and polyphenylene sulfide.

Materials in addition to the adsorption material, the polymer, and the reinforcement material can be used. For example, in some embodiments, silver nanoparticles (Nano Silver) can be added to the mixture to strengthen an antibacterial or antimicrobial performance of the resulting filter media.

Mixing the materials can include forming a homogeneous mixture. In some embodiments mixing can include mechanical blending. Embodiments herein are not intended to be limited to one or more particular methods of forming a homogenous mixture.

At block 104, method 100 includes compressing the mixture. In some embodiments, the mixture can be compressed in a mold (e.g., a fixed mold). In some embodiments, the mixture can be extruded. The size and or shape of the mold can be selected based on a desired size and shape of the resulting filter medium. A level of compression can be selected based on the materials used and/or the desired air flow rate through the resulting filter medium.

At block 106, method 100 includes heating the mixture. In some embodiments, the mixture can be compressed and heated simultaneously. In some embodiments, heating can be initialized after the compression is initialized. Heating can be carried out in the same mold in which the compression occurred. In some embodiments, heating can be initialized after the compression is completed. The mixture can be heated to a temperature between 100 degrees Celsius and 600 degrees Celsius, for instance.

Heating the mixture can include heating the mixture to a temperature within a threshold of a melting point of the polymer (e.g., approaching a melting point of the polymer). As previously discussed, because the type of polymer(s) used can be selected, an appropriate temperature can be applied to partially melt the polymer. In order to decrease the weight loss of the adsorption material, nitrogen atmosphere protection can be utilized during heating.

After compression and heating, the mixture can be allowed to cool. The partially-melted polymer can re-harden during cooling and adhesively bind a surface of the adsorption material and a surface the reinforcement material. Depending on the reinforcement medium used, a rigid or semi-rigid filter medium is processed. The medium can be trimmed to a desired size and/or shape, for instance, and can be used to filter gas pollutants out of air.

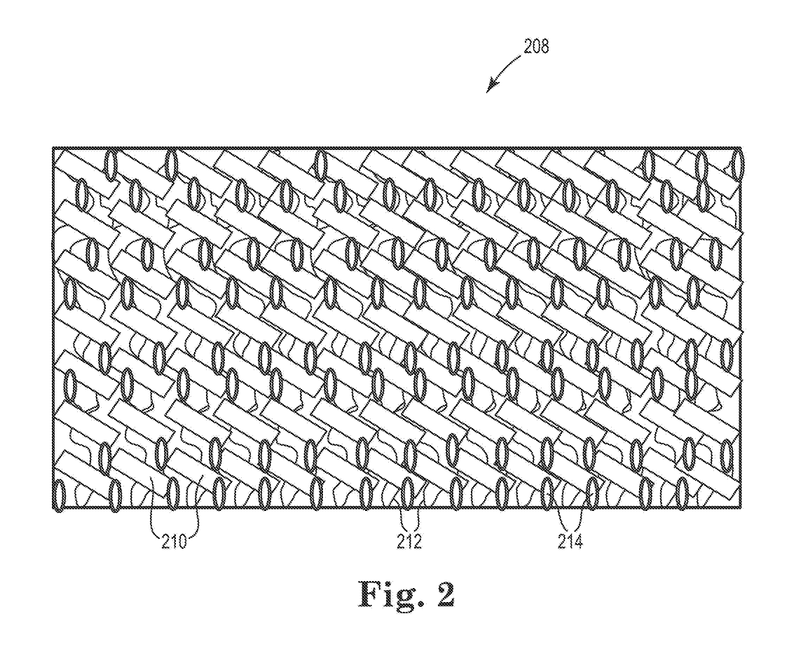

FIG. 2 illustrates a cross-sectional view of an example air filtration medium 208 in accordance with one or more embodiments of the present disclosure. As shown in FIG. 2, the medium 208 includes a substantially homogeneous arrangement of a cylindrical adsorption material 210, a reinforcement material 212, and a polymer 214. As shown, the reinforcement material 212 can form a thin “skeleton” which, when bound to the adsorption material 210 via the polymer 214, provides structural stability to the filter medium 208.

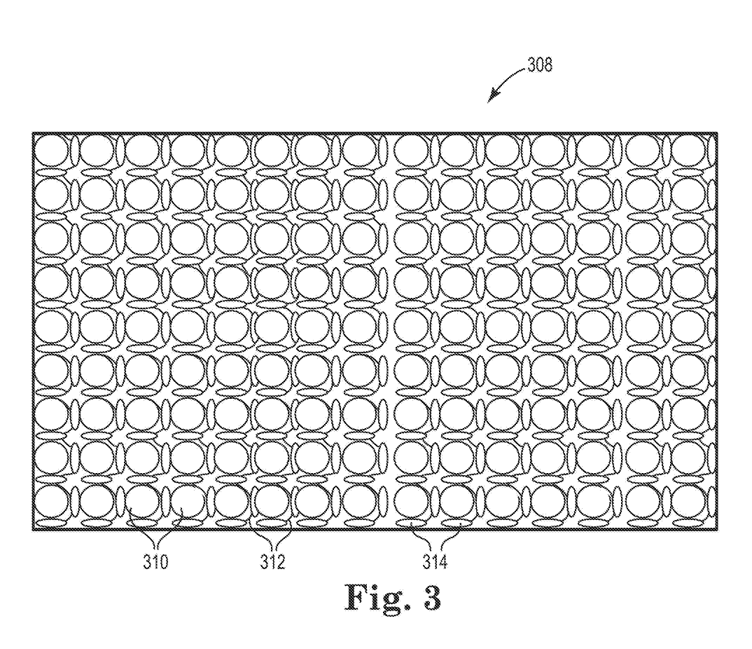

FIG. 3 illustrates a cross-sectional view of another example air filtration medium 308 in accordance with one or more embodiments of the present disclosure. As shown in FIG. 3, the medium 308 includes a substantially homogeneous arrangement of a spherical adsorption material 310, a reinforcement material 312, and a polymer 314. As shown, the reinforcement material 312 can form a thin “skeleton” which, when bound to the adsorption material 210 via the polymer 214, provides structural stability to the filter medium 208.

In either case, the homogeneous character of the medium 208 and the medium 308 does not allow air to pass through “shortcuts” through the medium seen in previous approaches. Gas pollutants passing through media in accordance with embodiments herein encounter more adsorption material than in previous approaches. For example, the lack of a honeycomb structure allows embodiments of the present disclosure to increase a ratio of adsorption material to structural elements contained in filter media.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for processing an air filtration medium, comprising:
mixing an adsorption material, a polymer material, and a reinforcement material;
compressing the mixture; and
heating the mixture.

2. The method of claim 1, wherein the adsorption material includes at least one of: activated carbon, a molecular sieve material, and diatomite.

3. The method of claim 1, wherein the polymer material includes at least one of: polypropylene, low-density polyethylene, and high-density polyethylene.

4. The method of claim 1, wherein the reinforcement material includes at least one of: activated carbon fiber, glass fiber, basalt fiber, polyethylene terephthalate fiber, and polyphenylene sulfide.

5. The method of claim 1, wherein compressing the mixture and heating the mixture are carried out via a same mold.

6. The method of claim 1, wherein heating the mixture includes heating the mixture to a temperature between 100 degrees Celsius and 600 degrees Celsius.

7. The method of claim 1, wherein the adsorption material includes one of: cylindrical particles and spherical particles.

8. The method of claim 1, wherein each of the adsorption material, the polymer material, and the reinforcement material are in a solid state, and wherein heating the mixture includes heating the mixture to a temperature within a threshold of a melting point of the polymer material.

9. The method of claim 1, wherein the mixture includes:
the adsorption material in a range of 50 percent to 90 percent by weight; and
the reinforcement material and the polymer material in a range of 5 percent to 50 percent by weight.

10. The method of claim 1, wherein the method includes compressing the mixture and heating the mixture simultaneously.
